(19) United States
(12) Patent Application Publication
(10) Pub. No.: US 2017/0214077 A1
(43) Pub. Date: Jul. 27, 2017

(54) Electrolyte System For Rechargeable Flow Battery

(71) Applicant: EnSync, Inc., Menomonee Falls, WI (US)

(72) Inventors: Peter Lex, Menomonee Falls, WI (US); Wu Bi, Milwaukee, WI (US)

(21) Appl. No.: 15/416,620

(22) Filed: Jan. 26, 2017

Related U.S. Application Data
(60) Provisional application No. 62/287,524, filed on Jan. 27, 2016.

(51) Int. Cl. H01M 8/18; H01M 8/08

(52) U.S. Cl. CPC H01M 8/188; H01M 8/08; H01M 2300/0002

(57) ABSTRACT

An electrolyte system is provided for a rechargeable electrode zinc-halogen flow battery that utilizes a highly similar or identical electrolyte positioned on both sides of an ion-conducting membrane. The electrolyte system containing zinc salts, electrolyte conductivity enhancer, and an appropriate amount of bromine complexing agent achieves significant improvements on battery energy efficiency, self-discharge rate, and electrolyte level cycle stability over the prior art electrolyte systems.

### CROSS-REFERENCE TO RELATED APPLICATIONS

This application claims priority from U.S. Provisional Patent Application Ser. No. 62/287,524, filed on Jan. 27, 2016, the entirety of which is expressly incorporated by reference herein for all purposes.

### FIELD OF THE INVENTION

The present invention relates generally to rechargeable flow batteries, and more specifically to the charge-carrying compounds utilized in zinc-halogen batteries

### BACKGROUND OF THE INVENTION

Rechargeable flow batteries, including, for example, those disclosed in US Patent Application Publication No. US2012/0326672 entitled Reversible Polarity Operation And Switching Method For ZnBr Flow Battery When Connected To Common DC Bus, and U.S. Pat. Nos. 4,049,886: 5,002,841; 5,188,915 and 5,650,239, each of which is expressly incorporated by reference herein for all purposes in its entirety, utilize electrolytes incorporating metal ion redox couples/compounds, including but not limited to vanadium, zinc-halogen, and other compounds within the electrolyte. The electrolyte compositions in most commercial flow battery technologies utilize water-based electrolyte, although organic compounds in non-aqueous media are gaining more attention. Commonly, carbon-based electrodes are utilized as both positive electrode and negative electrode in a single battery cell, or used as bi-polar electrodes in a multi-cell battery stack. A microporous separator or ion-exchange separator is placed between anolyte and catholyte. to prevent gross mixing of both electrolytes and/or to minimize self-discharge of flow battery. Both anolyte and catholyte are pumped from their own electrolyte tank to the battery cell or stack and then re-circulated back into its own tank, allowing electrolyte reactions to take place on the electrodes during either of the processes of battery charging or battery discharging.

For a flow battery such as zinc-bromine flow battery, the essential electrolyte component is ZnBr₂ salt. When a zinc-bromine flow battery is charged, zinc ions are reduced to zinc metal that is accumulated on negative electrode. and bromide ions are oxidized forming bromine Br₂ on positive electrode. Then during its discharge, the accumulated zinc metal on the negative electrode (anode) is dissolved into zinc ions and bromine molecules Br₂ are reduced to bromide ions at the positive electrode (cathode). Using this process a charge-discharge cycle for the battery is completed, and this cycle can be repeated multiple times utilizing the battery.

For zinc-bromine rechargeable flow batteries. the catholyte and anolyte utilized therein are different from one another. More specifically, the catholyte and anolyte can contain different chemical compounds and additives, which allows the properties of the catholyte and the anolyte to be individually tailored for better battery performance. In certain batteries, this is a result of the main electrolyte component ZnBr₂ being improved or substituted for to include some amount of ZnCl₂, ZnF₂, or ZnSO4 within the electrolyte used as the anolyte or the catholyte to alter the electrode potential of ZnBr₂ sufficiently to minimize each of hydrogen generation, acidity loss, and dendrite formation during long-term constant voltage charging (floating operation) such as shown and disclosed in U.S. Pat. Nos. 3,806,368; 4,491,625 and 5,188,915, each of which are expressly incorporated herein by reference in their entirety for all purposes.

During charging of these prior art electrolyte batteries, heavy bromine is generated in the redox reaction and settles down in the positive electrolyte, Typically ZnBr₂ concentration is in the range of 2.0-3.0 M. An increase of ZnBr₂ concentration improves battery energy density, but increases cell resistance with reduced electrolyte conductivity. Electrolyte pumping power consumption will also increase due to higher electrolyte density and viscosity at a higher ZnBr₂ concentration. Chemical material, cost is also consequently increased.

To address this, in prior art electrolyte flow batteries a bromine complexing agent (abbreviated as Q-Br) or a mixture of several complexing agents, such as 1-Ethyl-1-methylpyrrolidinium bromide (MEP-Br) which, is a widely used complexing agent, is often added into electrolyte to bind several (n) bromine molecules Br₂, which forms bromine-bromide complexes Q-Br₂ₙ₊₁ that settle down in the catholyte tank as a distinctly different phase from the aqueous catholyte phase. This oil-like bromine-bromide complex phase is commonly referred as the second phase. With the use of the Q-Br complexing agent, bromine evaporation loss from the catholyte is minimized to maintain the battery charge capacity, as disclosed in U.S. Pat. Nos. 5,188,915; 4,510,218 and 4,105,829, each of which is, expressly incorporated herein by reference for all purposes. it is also safer to operate zinc-bromine flow battery in any event of electrolyte spill as a result of the bromine vapor suppression ability of the complexing agent.

Another commonly used complexing agent is N-Methyl-N-Ethyl Morpholinium Bromide (MEM-Br), which is less expensive but has a lower bromine vapor suppression ability than MEP-Br. Sometimes, MEP-Br mixed with MEM-Br is utilized in zinc-bromine flow batteries. If MEP-Br is used by itself, a concentration of 0.6-1.2 M has been utilized in the prior art electrolyte systems, and further increase of MEP-Br concentration does not further reduce electrolyte bromine vapor. However, the addition of the complexing agent to the catholyte further differentiates the composition of the catholyte from, the composition of the anolyte.

In another example, in a prior art battery disclosed in U.S. Pat. No. 3,929,506, which is expressly incorporated by reference herein in its entirety for all purposes, bromide-containing salts, such as NaBr, were utilized without any zinc salts in the catholyte, and zinc-containing salts, such as ZnCl₂, mixed with a conductivity enhancer, such as NaCl, were utilized without any bromide salts in the anolyte. The anolyte and, catholyte were separated by art ion-conducting diaphragm, which functions similarly to a cation-exchange separator to allow only cations to pass through the diaphragm.

However, in analyzing the operation of these batteries, it was determined that stable electrolyte levels were very hard to maintain due to different electrolyte properties such as density, viscosity, and concentration, between the catholyte and the anolyte. In particular, often the catholyte volume quickly decreased while the anolyte volume increased, due to combined driven forces of concentration gradient, pressure gradient, and electric field. This resulted in fast cell performance decay and eventually premature failure of the battery.

In addition to these issues, the prior art zinc-bromine flow batteries had far lower energy efficiency than commercial Li-ion battery. As shown in Table 1 below, charge-discharge cycle coulombic efficiency or charge efficiency (CE %) was only up to 85% in those battery configuration disclosed in prior art patents and their energy efficiency (EE %), which is not shown, is most likely well below 75%. This assumption is correct as a prior art standard electrolyte SEC1R (2.5 M ZnBr₂ mixed with 0.8 M MEP-Br) was tested in a zinc-bromine flow battery constructed with a microporous-type separator, and its energy efficiency (EE %) within a charge-discharge cycle was determined to be around 74%. The low battery voltage efficiency (VE %) or high battery resistance with electrolytes of this type is partially due to low electrolyte conductivity. Further, the prior art catholyte largely drifted into the anolyte side with repeated electrolyte composition changes during charge-discharge cycles of these prior art batteries.

In summary, it is desirable to develop a better electrolyte system including a catholyte and an anolyte that can be utilized to provide more efficient and more consistent battery performance than the prior art electrolyte systems. In particular, it is desired to develop an electrolyte formulated to reduce self-discharge rate, hence to improve battery coulombic efficiency (CE %) and energy efficiency (EE %).

### SUMMARY OF THE INVENTION

Therefore, according to one aspect of an exemplary embodiment of the invention, an Unproved electrolyte system is provided for better and stable performance of a zinc-bromine flow battery with an ion-exchange membrane placed between the anolyte and the catholyte. The catholyte and anolyte are formed of a symmetric electrolyte, such that the anolyte and catholyte have identical compositions, which results in minimal electrolyte drifting from catholyte to anolyte. In addition, the use of identical main compounds for both anolyte and catholyte eases the manufacturing and field maintenance service of the battery.

According to another aspect of an, exemplary embodiment of the invention, to the anolyte and catholyte compositions is added a conductivity enhancer(s) which can significantly improve, electrolyte conductivity and voltage efficiency (V %).

Further, with the ion-exchange membrane or separator, bromine molecules in the aqueous phase or bromine-bromide complexes in the second phase cannot readily permeate through ion-exchange membrane, Hence, the bromine complexing agent concentration in the electrolyte may be reduced for a zinc-bromine flow battery with the ion-exchange separator to only an amount required to reduce bromine vapor loss or minimize bromine vapor safety concern in any possible event of electrolyte leakage.

Numerous other aspects, features, and advantages of the invention will be made apparent from the following detailed description together with the drawing figures.

### BRIEF DESCRIPTION OF THE DRAWINGS

The drawing figures illustrate the best mode currently contemplated of practicing the invention.

In the drawings:

FIG. 1 is a schematic diagram of a stack of alternatively disposed zinc-bromine battery components, cooperating with electrolyte reservoirs according to an exemplary embodiment of the invention.

FIG. 2 is a perspective, exploded view of a stack of alternately disposed zinc-bromine battery components according to an exemplary embodiment of the invention.

FIG. 3 is a schematic diagram of a zinc-bromine battery cell showing electrolyte flow to and from the reservoirs and through the battery according to an exemplary embodiment of the invention.

FIG. 4 is a graph of the battery AC impedance increase with increased MEP concentration in anolyte and catholyte.

FIG. 5 is a graph of the electrolyte volume levels in an electrolyte flow battery constructed according to an exemplary embodiment of the invention over number of charge/discharge cycles.

FIG. 6 is a graph of the voltage efficiency of an electrolyte flow battery constructed according to an exemplary embodiment of the invention over number of charge/discharge cycles,

FIG. 7 is a graph of the energy efficiency of an electrolyte flow battery constructed according to an exemplary embodiment of the invention over number of charge/discharge cycles.

FIG. 8 is a graph of the columbic efficiency of zinc-bromine flow batteries constructed according to an exemplary embodiment of the invention with the developed electrolyte systems over number of charge/discharge cycles.

FIG. 9 is a graph of the voltage efficiency of zinc-bromine flow batteries constructed according to an exemplary embodiment of the invention with the developed electrolyte systems over number of charge/discharge cycles.

FIG. 10 is a graph of the energy efficiency of zinc-bromine flow batteries constructed according to an exemplary embodiment of the invention with the developed electrolyte systems over number of charge/discharge cycles.

### DETAILED DESCRIPTION OF THE INVENTION

In exemplary embodiments of the invention, an improved electrolyte system for use in an electrolyte flow battery, as are known in the art, is provided.

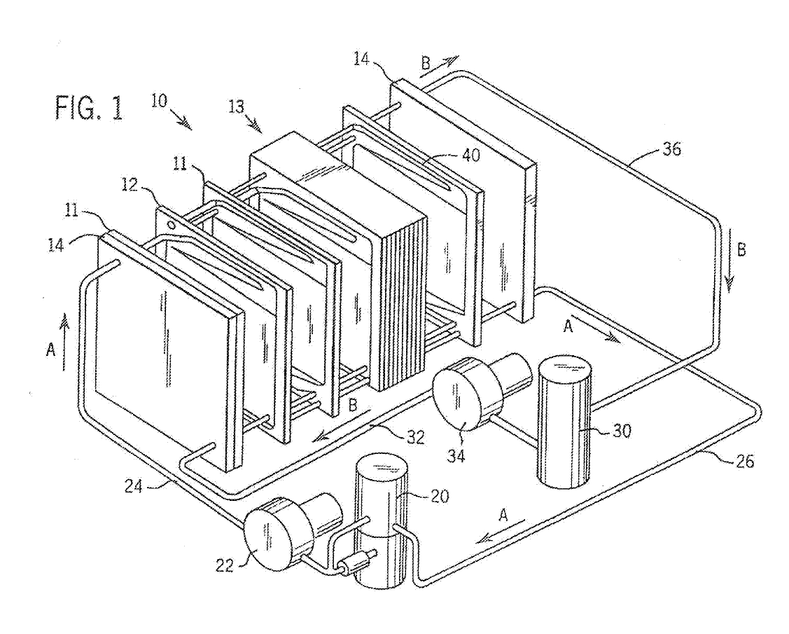

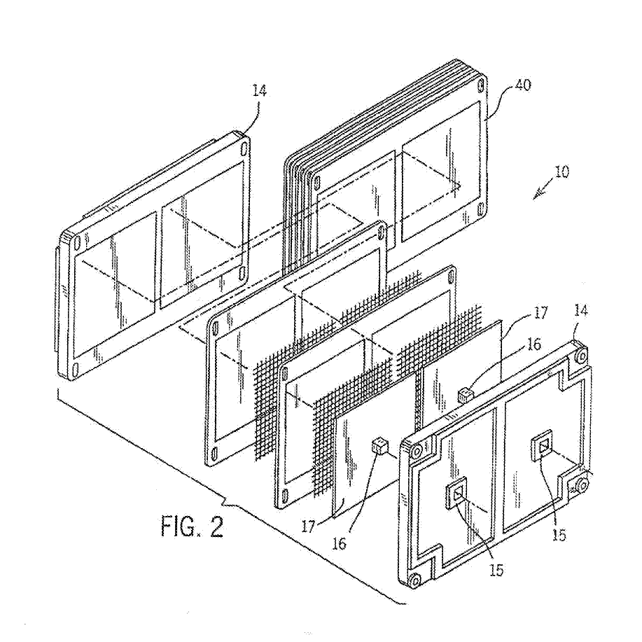

Referring more particularly to the drawings, one particular exemplary embodiment of an electrolyte flow battery including zinc complexes, as are known in the art, such as U.S. Pat. Nos. 4,049,886; 5,002,841; 5,188,915 and 5,650,239, and US Patent Application Publication No. 2012/0326672, each of which is expressly incorporated by reference herein for all purposes in its entirety, and which each disclose a zinc-bromine battery. is shown in an exploded view and is designated generally by the numeral 10 in FIG. 1. The zinc-bromine battery 10 includes a series of electrodes 11 and separators 12, welded together to form a stack 13 of electrochemical cells. Each battery 10 includes a predetermined number of electrodes 11 and separators 12 and. thus, a predetermined number of electrochemical cells. As best seen in FIG. 2, respective endblocks 14 are disposed at each end of the battery 10. The endblocks 14 each have a pair of openings 15 in which a pair of terminal studs 16 are positioned. The terminal studs 16 are electrically coupled to the battery's terminal electrodes 17 which may be mounted directly adjacent to the endblocks. The terminal studs provide a convenient means through which current may enter and leave the battery. Bach terminal electrode is a current collector means capable of collecting current from, and distributing current to, the electrochemical cells of the battery. Although not shown, it should be understood that terminal electrodes arc mounted on, or are adjacent to, each end block.

Referring back to FIG. 1, aqueous, or optionally non-aqueous, catholyte is stored in a catholyte reservoir 20. A catholyte pump 22 pumps aqueous catholyte through a common catholyte manifold 24 into each cathodic half cell as indicated by the arrows labeled A in FIG. 1, and back to the catholyte reservoir 20 through a catholyte return manifold 26.

Similarly, aqueous, or optionally non-aqueous, anolyte is stored in an anolyte reservoir 30 and pumped through an anolyte inlet manifold 32 by an anolyte pump 34. The anolyte flows through each anodic half-cell, one of which is disposed between each cathodic half-cell, and back to the anolyte reservoir 30 through an anolyte return manifold 36, as indicated by the arrows labeled B in FIG. 1, Thus, the electrochemical cells of the battery 10 are coupled in fluid flowing, relation to the reservoirs 20 and 30 through the manifolds 24, 26, 32. and 36,

Each electrode and separator includes a thin sheet of electrode or separator material, respectively. These sheets are individually mounted in a nonconductive flow frame 40. Preferably, the nonconductive flow frame is made from a polymeric material such as, polyethylene. Long, winding electrolyte inlet and outlet channel patterns are incorporated into one or both sides of the separator frame, the electrode frame, or both. The geometry of the channels, contributes to the electrical resistance required to reduce shunt currents which result in cell power losses. A leak-free internal seal is maintained along the channels and about the common perimeter of adjacent separators and electrodes.

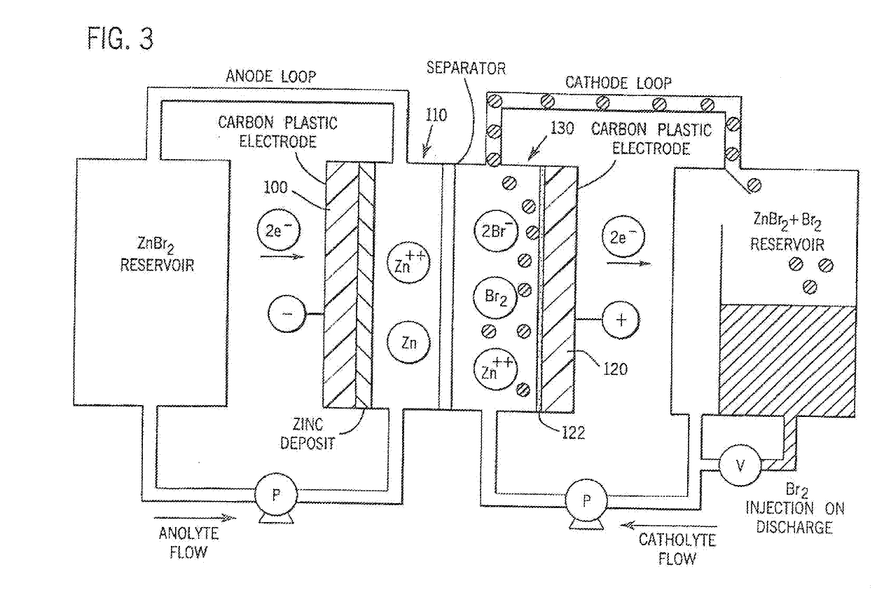

As can be more readily seen by reference to the schematic representation of FIG. 3, during charge electron flow through the battery 10 results in zinc being plated on an anode or zinc electrode 100 which is in an anodic half-cell 110. During the same time bromine is evolved at a cathode or bromine electrode 120 which is in a cathodic half-cell 130. When the bromine is evolved it is immediately complexed with a quaternary salt and is removed from the battery to the catholyte reservoir 30. The complexed bromine or dense second phase is separated by gravity from bromine in the reservoir. Normally, on discharge, the complexed bromine or second phase is returned to the battery stack were bromine is reduced to bromide ion and zinc metal is oxidized to zinc ion.

The electrolyte system including the anolyte and the catholyte in one exemplary embodiment is formed with a highly similar or identical electrolyte that is disposed on both sides of an ion-conducting membrane 12 within the electrolyte flow battery 10, such as a Nation® membrane, a Solvay® membrane, among other suitable ion exchange membranes, or a membrane/separator hybrid structure including one or more layers of an ion-conducting membrane with one or more layers of a microporous membrane to form a multi-layer structure for the separator 12. The non-ion-conducting porous separator(s) or microporous membrane includes, but is not limited to Asahi®, separator, Entek® separator, Daramic® separator, among other suitable separators.

With regard to the composition of the electrolyte forming the catholyte and the anolyte, which arc formed to be identical to one another, the main components of the electrolyte system include one or more Zn salts (at a concentration of 1-4 mol/L in one exemplary embodiment of the invention), optionally one or more conductivity enhancer(s), and optionally one or more bromine complexing agent(s). In addition to the main electrolyte components, electrolyte additives for various purposes can be added, including but not limited to additives for better bromine dispersion, less hydrogen evolution and more stable electrolyte pH, less zinc metal corrosion in acidic electrolyte, and etc.

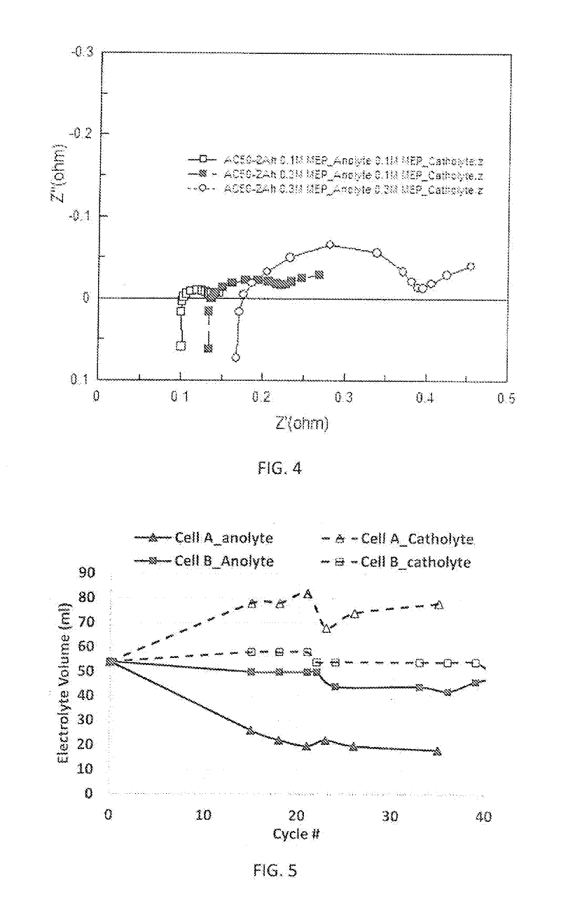

The bromine complexing agent can include, but is not limited to, Ethyl-1-methylpyrrolidinium (MEP) halide salts, N-methyl-N-ethyl morpholinium (MEM) halide salts, and any other suitable quaternary ammonium compounds and/or any mixture thereof In one exemplary embodiment of the invention, the concentration of bromine complex agent utilized in the electrolyte system is about 0.03-1.0 mol/L. The reason for the low amount of complexing agent is to reduce battery resistance as shown in FIG. 4 to be discussed later, hence provide better efficiency. Since a non-porous ion-exchange membrane is utilized, in the separator 12, bromine crosses over through the membrane or self-discharge is largely reduced already. In a conventional microporous membrane battery, much more bromine complex agent is required to reduce bromine cross over from catholyte to anolyte It is preferred to have a lower concentration of bromine complex agent in a cation-conducting membrane cell than a typical level, such as, for example, the level in SEC-1R of 0.8 M MEP-Br as has been utilized in a conventional zinc-bromine flow battery constructed with a microporous non-ion-conductive separator.

The conductivity enhancer(s) that can be added to the electrolyte can include, but are not limited to NaBr, NaCl, KBr, KCl, Na₂SO₄, K₂SO₄, NaF, KF, LiCl, LiBr, LiF, and/or any mixture of these compounds. The chloride salt(s), while capable of being utilized is often not preferred due to the tendency to form zinc “cement”, or insoluble zinc salts precipitated out of the electrolyte, which cause a rapid decay in battery cell performance. Bromide salt is a preferred type of conductivity enhancer, such as NaBr, in a Na-ion conducting membrane cell. This is also partially due to bromide ions in NaBr that can form complexes with bromine molecules Br₂ similarly as, although not as effectively as, the common bromine-complexing agent such as MEP-Br. In an exemplary embodiment of the invention, the concentration of conductivity enhancer is about 0.05-6.0 mol/L depending on saturated solubility, of the enhancer in water, Higher concentration (3.0-6.0 mol/L) of bromide salt, such as NaBr, is preferred as both a conductivity enhancer and a bromine complex agent at the same time.

In one exemplary embodiment, a zinc-bromine single cell flow battery was constructed with graphite plates for both anode and cathode, an identical electrolyte of 2.6 M ZnBr₂ mixed with 4.0 M NaBr and 0.1 M MEP-Br was utilized for both anolyte and catholyte. The battery was charged to 2Ah at 40° C. Then AC impedance of the battery was measured by a Solartron Potentiostat connected with a Frequency Response Analyzer. After that, MEP-Br concentration in the anolyte was increased from 0.1 M to 0.3 M, and AC impedance was measured again. Further, MEP-Br in catholyte was also increased front 0.1 M to 0.3 M before the final AC impedance measurement. As shown in FIG. 4, the dominant resistance increase was the increase of the charge-transfer resistance corresponding to the semi-circle diameter when MEP-Br concentration particularly in catholyte was increased from 0.1 M to 0.3 M. This clearly illustrates that amount of bromine complexing agent in the electrolyte should be minimized to improve cell resistance and efficiency. In a zinc-bromine flow battery with a microporous separator, battery self-discharge rate may additionally be increased with the reduced bromine complexing agent. Hence non-porous ion-exchange membrane is preferred when combined with significantly low amount of bromine complexing agent in electrolyte, to minimize cell self-discharge rate and reduce resistance at the same time.

In another exemplary embodiment of the invention, in a Zn-Br battery reference Cell A constructed similarly to that disclosed in U.S. Pat. No. 3,929,506, which is expressly incorporated by reference herein in its entirety for all purposes, with an ion-conducting separator, the aqueous anolyte was formed with 2.5 M ZnBr₂ with 3 M NaBr, and the aqueous catholyte was formed with 5 M NaBr and 0.3 M MEP-Br without any zinc ions. In Zn-Br battery Cell B, formed to be structurally similar to Cell A as disclosed in U.S. Pat. No. 3,929,506, but in which both the anolyte and the catholyte were formed to be identical, with each containing both zinc ions and bromide ions, and in an exemplary embodiment with each containing 2.5 M ZnBr₂, 3 M NaBr, and 0.3 M MEP-Br. Both Cells A and B utilized a Solvay® Na-ion conductive membrane therein, and all performance data were measured at 20 mA/cm² at 40° C. The results of the analyses of the electrolyte conductivity, electrolyte balance, CE %, VE % and EE % and self-discharge for the batteries is illustrated below in Table 1, as in FIGS. 5-10.

TABLE 1
Battery Analysis Results

| | | | Electrolyte | | | | | |
|---|---|---|---|---|---|---|---|---|
| | | | conductivity⁽¹⁾ | | | | | |
| | | | (mS/cm) at | | Avg. | | | |
| | | | 23° C. (a. for | | Efficiencies | | | |
| | | | anolyte and c. | Electrolyte | at 20 mA/cm², | | | Self- |
| | | | for catholyte | balance, | 40° C. | | | discharge |
| Electrolyte | Separator | Electrolyte | where | catholyte | CE | VE | EE | (wh % loss |
| ID | TyPe | Type | indicated) | vol. % loss | % | % | % | per hour) |
| U.S. Pat. No. | Microporous | Symmetric | — | — | 73- | — | <CE % | — |
| 3,806,368 | | | | | 85% | | | |
| U.S. Pat. No. | Ion- | Symmetric | — | — | 82- | — | <CE % | — |
| 4,105,829 | exchange | | | | 85% | | | |
| U.S. Pat. No. | Ion- | Symmetric | — | — | 75- | — | <CE % | — |
| 4,491,625 | exchange | | | | 82% | | | |
| SEC1R | Microporous | Standard | 78 | Poor, 70% | 90% | 82% | 74% | 1.5% |
| | | (prior-art) | | | | | | |
| DE5-5 | Ion- | Adv. non- | — | Poor, 45% | 96% | 88% | 84% | — |
| | exchange | symmetric | | | | | | |
| | | 1 | | | | | | |
| ACEE-4 | Ion- | Adv. non- | 94(a.); 122(c.) | Poor, 50% | 95% | 88% | 84% | — |
| | exchange | symmetric | | | | | | |
| | | 2 | | | | | | |
| A | Ion- | Adv. non- | 110(a.); 179(c.) | Poor, 65% | 95% | 86% | 81% | — |
| | exchange | symmetric | | | | | | |
| | | 3 | | | | | | |
| B | Ion- | Adv. | 84 | Good, 15% | 98% | 84% | 82% | — |
| | exchange | Symmetric | | | | | | |
| | | 1 | | | | | | |
| VT1-2 | Ion- | Adv. | 139 | Good, 10% | 97% | 86% | 83% | 0.3% |
| | exchange | Symmetric | | | | | | |
| | | 2 | | | | | | |
| VT1-5 | Ion- | Adv. | 152 | Good, 10% | 97% | 93% | 90% | 1.2% |
| | exchange | Synmetric | | | | | | |
| | | 3 | | | | | | |
| VT1-7 | Ion- | Adv. | 135 | Good, 6% | 97% | 83% | 81% | 0.2% |
| | exchange | Symmetric | | | | | | |
| | | 4 | | | | | | |
| VT1-8 | Ion- | Adv. | 150 | Good, 10% | 98% | 90% | 88% | 0.4% |
| | exchange | Symmetric | | | | | | |
| | | 5 | | | | | | |
| VT1-9 | Ion- | Adv. | 152 | Good, 4% | 98% | 85% | 83% | 0.3% |
| | exchange | Symmetric | | | | | | |
| | | 6 | | | | | | |

TABLE 2
Electrolyte Formulations

| Electrolyte | Re- | | |
|---|---|---|---|
| ID | name | Anolyte Formula | Catholyte Formula |
| SEC1R | Standard | 54 ml of Std. 2.5M ZnBr2 + 0.8M MEP | Same as anolyte |
| DE5-5 | C | 54 ml of 3.0M ZnCl2 + 2.0M NaCl | 54 ml of 4M NaBr + |
| | | | 0.3M MEP |
| ACEE-4 | D | 54 ml of 2.5M ZnBr2 + 3.0M NaBr | 54 ml of 6M NaBr + |
| | | | 0.4M MEP |
| A (ACR-A) | A | 54 ml of 2.5M ZnBr2 + 3.0M NaBr | 54 ml of 5M NaBr + |
| | | | 0.3M MEP |
| B (ACR-B) | B | 54 ml of 2.5M ZnBr2 + 3.0M NaBr + | Same as anolyte |
| | | 0.3M MEP | |
| VT1-2 | E | 54 ml of 2.7M ZnBr2 + 4.4M NaBr + | Same as anolyte |
| | | 0.2M MEP | |
| VT1-5 | F | 54 ml of 2.2M ZnBr2 + 3.0M NaBr | Same as anolyte |
| VT1-7 | G | 54 ml of 2.5M ZnBr2 + 3.0M NaBr + | Same as anolyte |
| | | 0.3M MEP | |
| VT1-8 | H | 54 ml of 2.6M ZnBr2 + 4.0M NaBr + | Same as anolyte |
| | | 0.1M MEP | |
| VT1-9 | I | 54 ml of 2.2M ZnBr2 + 3.0M NaBr + | Same as anolyte |
| | | 0.15M MEP | |

In reviewing the data concerning the electrolyte volume levels for Cells A and B, FIG. 5 shows that the catholyte m Cell A quickly migrated into the anolyte. Conversely, with the advanced symmetric electrolyte tot Cell B the electrolyte levels remained relatively stable, between the catholyte and anolyte volumes without any maintenance, Other tested non-symmetric electrolyte system DE5-5 and ACEE-4 showed slightly improved electrolyte balance, but still bad drift of catholyte into anolyte with cycles.

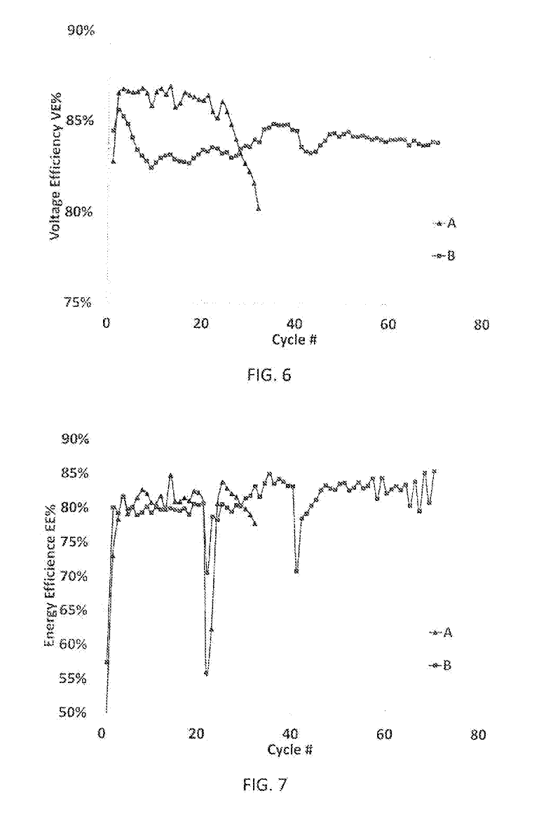

Referring now to FIGS. 6-7, these figures illustrate that Cell A had initial slightly higher efficiency than Cell B due to higher catholyte conductivity. But over a small number of charge/discharge cycles, Cell A quickly reached a limiting charge voltage of 2.2V and completely failed after 32 cycles due to the resistance increase. In contrast, Cell B maintained its voltage and energy efficiency over 60 cycles without any significant alterations due to the ability of Cell B to maintain the catholyte and anolyte levels relatively stable over the 60 cycles. Further, the large energy efficiency EE% dive peaks in FIG. 7 was due to an extended long-hour discharge to a zero cell voltage, a process called “cell stripping”.

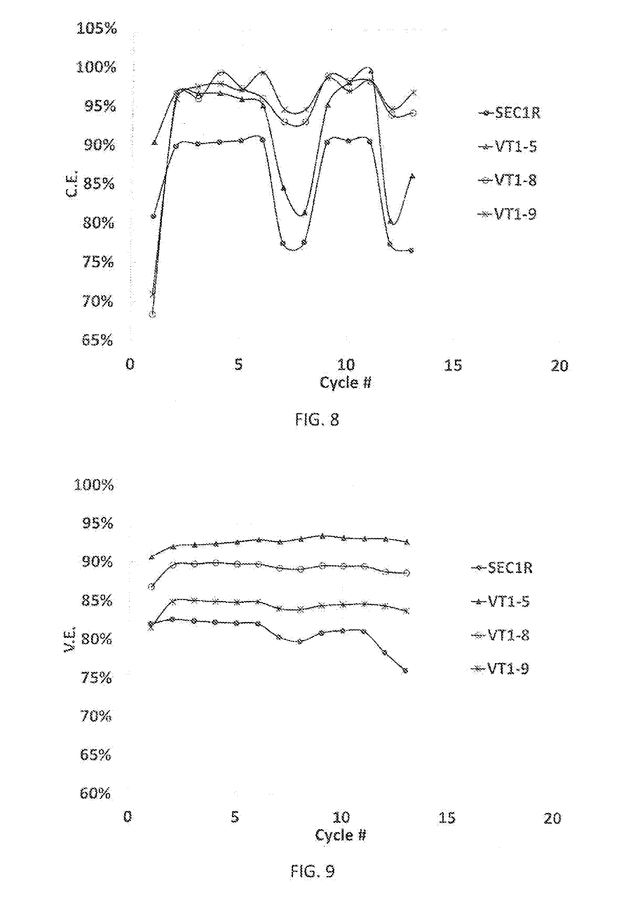

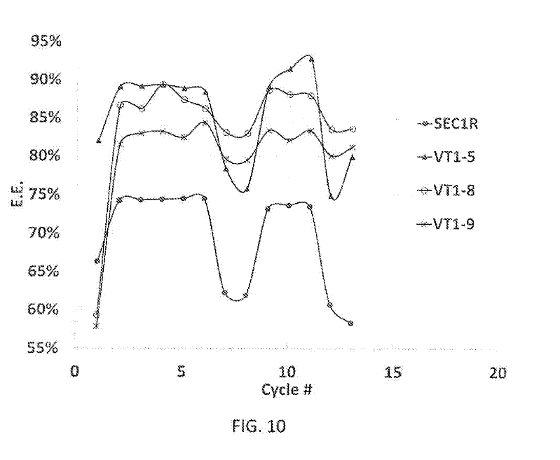

In other exemplary embodiments of the invention, the advanced symmetric electrolyte VT1-5 was utilized in a battery constructed similarly to that disclosed in US Patent No, 3,929,506 with an ion-exchanging separator as shown in Table 1. For comparative purposes, a similarly constructed battery utilized the standard electrolyte SEC1R on both sides of a microporous separator. No bromine complexing agent was utilized in VT1-5 electrolyte in comparison with 0.8 M MEP-Br in SEC1R electrolyte, Both batteries were charged to 2 Ah at 20 mA/cm² then discharged to 0.83V at 20 mA/cm² in repeated cycles at 40° C. During cycle 7, 8, 12, and 13, a period of 12 hours rest was followed after 2 Ah charged before the discharge step, with electrolytes on constant circulation between electrolyte tank and the battery. From the columbic efficiency plot of FIG. 8, both batteries had a large charge efficiency loss due to fast self-discharge during the 12-hour rest. Both voltage efficiency and energy efficiency of the battery with VT1-5 electrolyte was largely improved over SECT R battery as shown in FIG. 9 and FIG. 10, respectively. As shown in Table 1, the average self-discharge rate for VT1-5 electrolyte without any bromine complexing agent was 1.2% wh loss per hour, which was in fact lower than a rate of 1.5% wh loss per hour with the standard SEC1R electrolyte, This clearly showed that the non-porous ion-conducting separator reduced aqueous bromine cross-over rate through the separator. A self-discharge level more, than 1.0% wh loss per hour will quickly discharge a charged battery by itself at rest over the course of three to four days. So even with non-porous ion-conducting separator to minimize battery self-discharge rate. it is still not sufficient when no bromine complexing agent was utilized in the advanced electrolyte VT1-5.

In another further improved exemplary embodiments of the invention, a small amount of MEP-Br, with a preferred concentration range of 0.1-0.3 M, was utilized in electrolyte VT1-2, VT1-7, VT1-8 and VT1-9. All these electrolyte systems resulted in the significantly lower battery self-discharge rate than electrolyte VT1-5 without bromine complexing agent, as shown in Table 1. For example, charge efficiency (CE%) loss during the 12-hour self-discharge rest was largely reduced with electrolyte VT1-8 and VT1-9 as shown in FIG. 8, and the average self-discharge rate was largely reduced to 0.4% and 0.3% wh loss per hour in VT1-8 and VT1-9, respectively, as shown in Table 1. With the increase of MEP-Br concentration over electrolyte VT1-5 that was used in VT1-8 and VT1-9, both voltage efficiency and energy efficiency decreased as expected, Still both VT1-8 and VT1-9 had a large improvement of energy efficiency over the prior art electrolyte SEC1R. In particular, electrolyte VT1-8 achieved an excellent balance of energy efficiency, electrolyte level stability, battery self-discharge rate, and bromine chemical safety,

According to still other exemplary embodiments of the invention, the electrolyte system is not limited to only include zinc salts, conductivity enhancer, and bromine complex agent. The electrolyte may also contain other minor additives including, but not limited to, a zinc dendrite inhibitor(s), hydrogen evolution suppresser(s), and a surfactant(s), among others.

Various other embodiments of the invention are contemplated as being within the scope of the filed claims particularly pointing out and distinctly claiming the subject matter regarded as the invention,

1. An electrolyte system for a rechargeable electrolyte flow battery, the electrolyte system comprising:
a) an anolyte; and
b) a catholyte, wherein the catholyte is formed identically to the anolyte.

2. The electrolyte system of claim 1 wherein the anolyte and catholyte comprise;
a) a zinc salt;
b) one or more conductivity enhancer(s); and
c) one or more bromine complexing agent(s).

3. The electrolyte system of claim 1 wherein the bromine complexing agent is selected form the group consisting of ethyl-1-methylpyrrolidinium (MEP) halide salts, N-methyl-N-ethyl-morpholinium (MEM) halide salts, quaternary ammonium compounds and any mixtures thereof.

4. The electrolyte system of claim 3 wherein the bromine complexing agent is present in an amount between 0.0 M to 0.3 M.

5. The electrolyte system of claim 3 wherein the bromine complexing agent is present in an amount between 0.1 M to 0.3 M.

6. The electrolyte system of claim 1 wherein the conductivity enhancer is selected from the group consisting of NaBr, NaCl KBr, KCl, Na₂SO₄, K₂SO₄, NaF, KF, LiCl, LiBr, LiF, and a mixture of these compounds.

7. The electrolyte system of claim 6 wherein the conductivity enhancer is present in an amount of between 0.05-6.0 mol/L.

8. The electrolyte system of claim 6 wherein the conductivity enhancer is present in an amount of between 3.0-6.0 mol/L when the conductivity enhancer is a bromide salt. 9, The electrolyte system of claim 8 wherein the bromine complexing agent is absent,

10. The electrolyte system of claim further comprising at least one of a zinc dendrite inhibitor(s), hydrogen evolution suppresser(s), and a surfactant(s).

11. The electrolyte system of claim I wherein the composition of the anolyte and the catholyte comprises:
a) 2.6 M ZnBr₂;
b) 4.0 M NaBr; and
c) 0.1 M MEP.

12. The electrolyte system of claim 1 wherein the composition of the anolyte and the catholyte comprises:
a) 2.2 M ZnBr₂;
b) 3.0 M NaBr; and
c) 0.15 M MEP.

13. The electrolyte system of claim 1 wherein the composition of the anolyte and the catholyte comprises:
a) 2.2 M ZnBr₂; and
b) 3.0 M NaBr.

14. A method of improving the efficiency of a rechargeable electrolyte flow battery, the method comprising the steps of:
a) adding an anolyte to the battery; and
b) adding a catholyte to the battery, wherein the catholyte is formed identically to the anolyte.

15. A rechargeable zinc-bromine electrolyte flow battery, the battery comprising;
a) an anolyte formed, of a zinc salt, one or more conductivity enhancers and optionally one or more bromine complexing agents;
b) a catholyte formed identically to the anolyte; and
c) an ion-conducting membrane positioned between the anolyte and the catholyte.

16. A rechargeable zinc-bromine electrolyte flow battery, the battery comprising;
a) an anolyte formed of a zinc salt one or more conductivity enhancers and optionally one or more bromine complexing agents;
b) a catholyte formed identically to the anolyte; and
c) a membrane/separator hybrid structure consisting of one or more layers of an ion-conducting membrane with one or more layers of a porous non-ion-conducting separator.
